(19) United States
(12) Patent Application Publication
(10) Pub. No.: US 2004/0227473 A1
(43) Pub. Date: Nov. 18, 2004

(54) Non-reciprocal circuit element for adjusting magnetic flux density by a gap between two yokes and method for manufacturing the same

(75) Inventors: Yuichi Shimizu, Fukushima-ken (JP); Takamitsu Shibayama, Fukushima-ken (JP); Eiichi Komai, Niigata-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/842,897

(22) Filed: May 10, 2004

(30) Foreign Application Priority Data
May 14, 2003 (JP) 2003-135301

(51) Int. Cl. H02K 41/00

(52) U.S. Cl. 318/114

(57) ABSTRACT

A non-reciprocal circuit element and a method for manufacturing the same are provided to controls a magnetic flux density between first and second yokes and reduce variation in resonant frequency. The non-reciprocal circuit element includes a first yoke for covering a magnetic, and a second yoke which is disposed below the ferrite member and forms a closed magnetic circuit together with the first yoke. A gap capable of controlling the magnetic flux is provided between the first and second yokes, making it possible to change the gap width of the gap G, thereby adjusting the magnetic flux between the first and second yokes.

### BACKGROUND OF THE INVENTION

1. Field of the Invention

The present invention relates to a non-reciprocal circuit element such as a circulator or an isolator which is used for a transmitting and receiving system and a method for manufacturing the same.

2. Description of the Related Art

The conventional non-reciprocal circuit element will now be described with reference to FIGS. 9 and 10. FIG. 9 is an exploded perspective view showing a conventional non-reciprocal circuit element. FIG. 10 is a perspective view showing a state in which the conventional non-reciprocal circuit element shown in FIG. 9 is mounted.

A box-shaped first yoke 51 includes an upper surface plate 51a and four side plates 51b. The four side plates 51b are bent upwards from four sides of the upper surface plate 51a. A magnet 52 is arranged in the first yoke 1.

A ferrite member 53 is arranged at a lower part of the magnet 52. Three central conductors are attached to the ferrite member 53 and intersect by being separated from one another by an angle of 120 degrees (which are not shown in drawings).

An U-shaped second yoke 52 is arranged at a lower part of the ferrite member 53. The second yoke 54 includes a bottom plate 54a and a pair of side plates 54b. The pair of side plates 54b are bent upwards from sides of the bottom plate 54a which face each other.

A magnet 52 and a ferrite member 53 are interposed between the first and second yokes 51 and 54. The pair of side surface plates 51b and the pair of side plates 54b overlap each other. The overlapping parts are soldered to connect the first and second yokes 51 and 54 with each other, so that a closed magnetic circuit is formed in the first and second yokes 51 and 54.

The conventional non-reciprocal circuit element having the above construction is mounted on a printed board 55.

However, due to a manufacturing variation, the variation occurs in the magnitude of a magnetic force. In the same manner as the prior art, the side surface plates 51b and the side plates 54b overlap each other. When the overlapping parts are soldered, a magnetic flux density between the first and second yokes 51 and 54 changes due to the variation in the magnetic force. Accordingly, a bias is generated in the magnetic dispersion, causing a resonant frequency to be increased.

In the conventional non-reciprocal circuit element, when side surface plates 51b and side plates 54b overlap each other and the overlapping parts are soldered, the magnetic flux density between the first and second yokes 51 and 54 changes due to variation in a magnetic force. Accordingly, the conventional non-reciprocal circuit element has a problem in that the variation occurs in a magnetic bias, thereby causing a variation in a resonant frequency to increase.

### SUMMARY OF THE INVENTION

Therefore, it is an object of the present invention to provide a non-reciprocal circuit element that can control a magnetic flux density between first and second yokes and reduce the variation in a resonant frequency, and a method for manufacturing the same.

As the first solving means to solve the above problems, there is provided a non-reciprocal circuit element comprising a flat ferrite member, first, second, and third central conductors disposed on the ferrite member, the central conductors being provided on different surfaces in the longitudinal direction by interposing dielectrics therebetween, and the central conductors being partially intersected in the longitudinal direction, a magnet arranged on the first, second, and third central conductors, a first yoke disposed so as to cover the magnet, and a second yoke arranged at a lower surface side of the ferrite member for defining a closed magnetic circuit with the first yoke. A gap which is capable of controlling the magnetic flux density is provided between the first and second yokes.

An opening is formed as a gap according to second solving means.

As third solving means, the first and second yokes are connected with each other by connecting means.

As fourth solving means, the first and second yokes are connected with each other by the connecting means and/or by soldering the gap.

As fifth solving means, a concave portion is provided at one of the first and second yokes, a convex portion is provided at the other of the first and second yokes, and the connecting means is formed by concave and convex fitting of the concave and convex portions.

As sixth solving means, the first yoke includes an upper surface plate and at least one pair of side surface plates bent downward from the upper surface plate; the second yoke includes a bottom plate and at least one pair of side plates bent upward from the lower plate; the connecting means is formed between the at least one pair of side surface plates of the first yoke and the at least one pair of side plates of the second yoke and the gap is formed between the side surface plate and edges of the side plate which face each other.

The gap is formed between surfaces of the first and second yokes which face each other as eighth solving means.

As ninth solving means, the gap is formed between a surface of one of the first and second yokes and an edge of the other of the first and second yokes which face the surface of the one of the first and second yokes.

As tenth solving means, the first yoke includes an upper surface plate; the second yoke includes a bottom plate and at least one pair of side plates bent upwards from the upper surface of the first yoke; and the connecting means is formed between the upper surface of the first yoke and the at least one pair of side plates of the second yoke; and the gap is formed between the edge of the side plate and a surface of the upper surface plate.

As eleventh solving means, the upper surface plate of the first yoke includes a concave portion provided at an edge of the upper surface plate, and a tongue piece bent at a position of the concave portion downward; and the at least one pair of side plates include the convex portion which is engaged with the concave portion, and the convex portion contacts with the tongue piece.

As twelfth solving means, the upper surface plate of the first yoke includes a projection piece which is extended and bent from an edge of the upper surface plate, and a gap width is adjusted between the projection piece and the edge of the side plate by bending the projection piece.

According to thirteenth solving means of the present invention, there is provided A method for manufacturing a non-reciprocal circuit element comprising a flat ferrite member; first, second, and third central conductors disposed on the ferrite member, the central conductors being provided on different surfaces in the longitudinal direction by interposing dielectrics therebetween, and the central conductors being-partially intersected in the longitudinal direction; a magnet arranged on the first, second, and third central conductors; a first yoke disposed so as to cover the magnet; a second yoke arranged at a lower surface side of the ferrite member for defining a closed magnetic circuit with the first yoke; and a gap provided between the first and second yokes for controlling a magnetic flux density, the method comprising the steps of adjusting a gap width by moving at least one of the first and second yokes and adjusting a magnetic flux density between the first and second yokes in the gap.

As fourteenth solving means, the first and second yokes are connected with each other by connecting means, and a gap width is adjusted by moving at least one of the first and second yokes against a connection force of the connecting means.

A gap width is adjusted by inserting a jig into the gap as fifteenth solving means.

As sixteenth solving means, the jig is formed by an elastic member having elasticity, and a gap width is adjusted by moving at least one of the first and second yokes against elasticity of the elastic member.

As seventeenth solving means, a plurality of jigs having different thicknesses are used, a magnetic force of the magnet is previously measured every lot, the plurality of jigs are selected every lot of the magnet so as to adjust a gap width.

As eighteenth solving means, after adjusting a gap width, the first and second yokes are connected with each other by the connecting means and/or by soldering the gap.

### BRIEF DESCRIPTION OF THE DRAWINGS

FIG. 1 is an exploded perspective view of a non-reciprocal circuit element according to a first embodiment of the present invention;

FIG. 2 is a cross-sectional view of main parts of the non-reciprocal circuit element shown in FIG. 1;

FIG. 3 is a cross-sectional view taken along the line 3-3 in FIG. 2;

FIG. 4 is a perspective view of main parts of the first and second yokes in the non-reciprocal circuit element according to the first embodiment of the present invention;

FIG. 5 is an exploded perspective of the main parts of the first and second yokes in the non-reciprocal circuit element according to the first embodiment of the present invention;

FIG. 6 is a view illustrating a method for manufacturing the non-reciprocal circuit element according to the present invention;

FIG. 7 is a perspective view of main parts of first and second yokes in a non-reciprocal circuit element according to a second embodiment of the present invention;

FIG. 8 is a perspective view of main parts of first and second yokes in a non-reciprocal circuit element according to a third embodiment of the present invention;

FIG. 9 is an exploded perspective view showing a conventional non-reciprocal circuit element; and

FIG. 10 is a perspective view showing a state that the conventional non-reciprocal circuit element is mounted.

### DESCRIPTION OF THE PREFERRED EMBODIMENT

Non-reciprocal circuit element and the method for manufacturing the same according to the present invention will now be described with reference to the drawings.

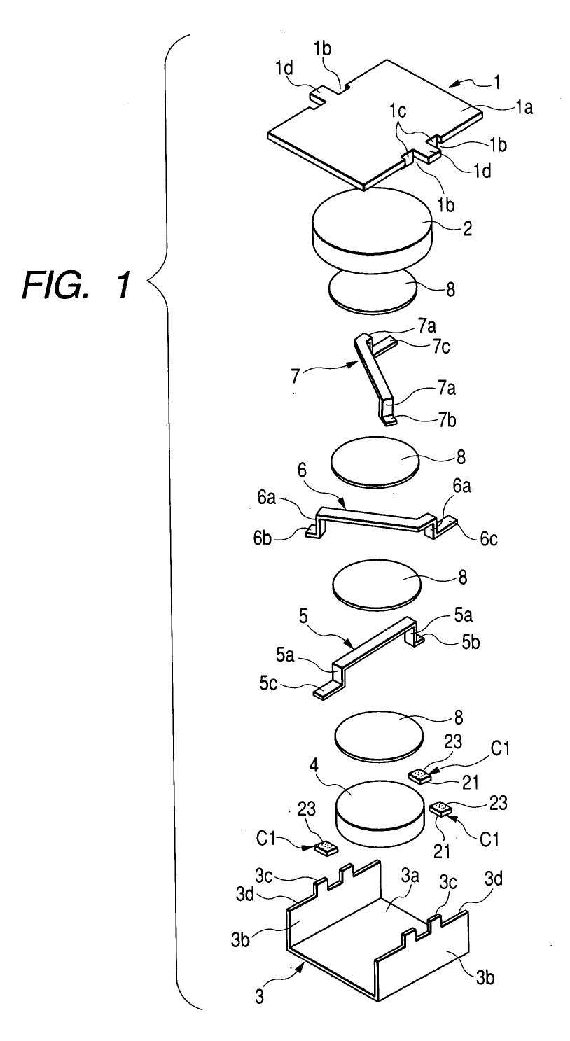

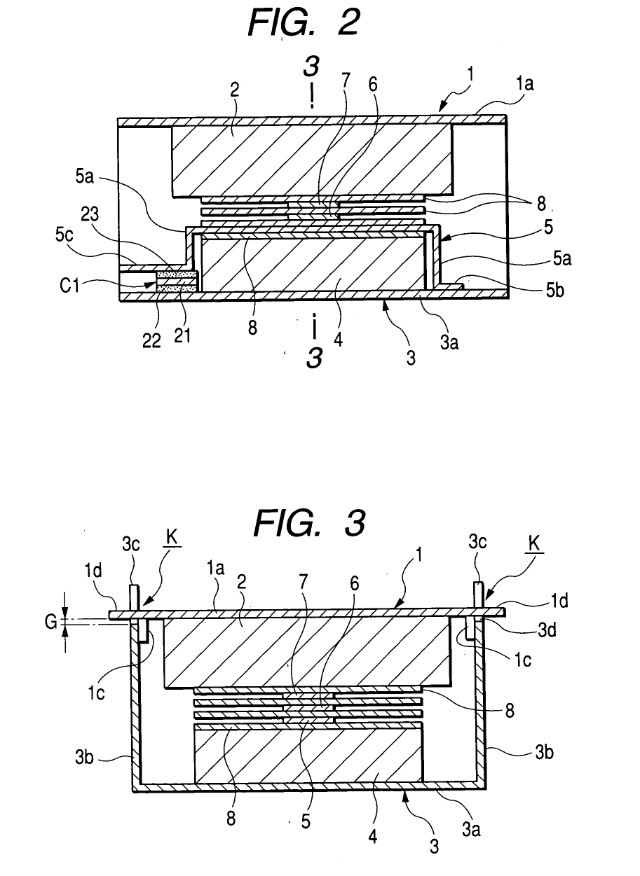

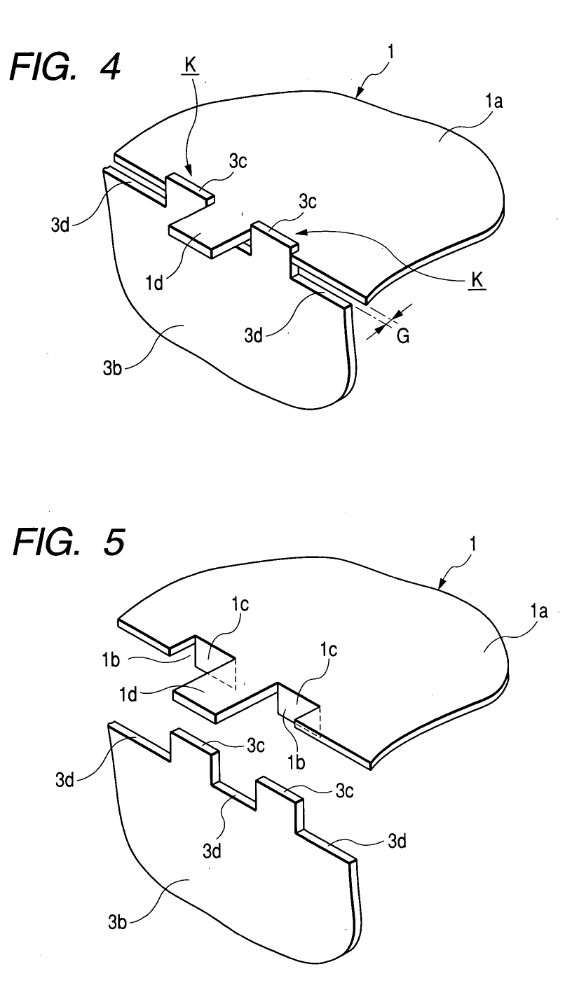

FIG. 1 is an exploded perspective view of a non-reciprocal circuit element according to a first embodiment of the present invention; FIG. 2 is a cross-sectional view of main parts of the non-reciprocal circuit element shown in FIG. 1; FIG. 3 is a cross-sectional view taken along the line 3-3 in FIG. 2; FIG. 4 is a perspective view of main parts of the first and second yokes in the non-reciprocal circuit element according to the first embodiment of the present invention; and FIG. 5 is an exploded perspective of the main parts of the first and second yokes in the non-reciprocal circuit element according to the first embodiment of the present invention.

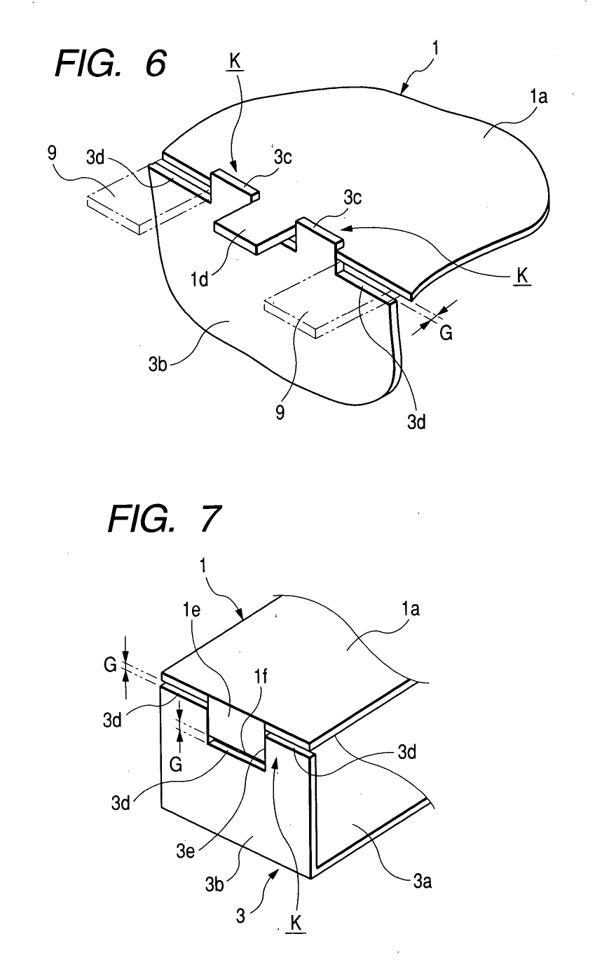

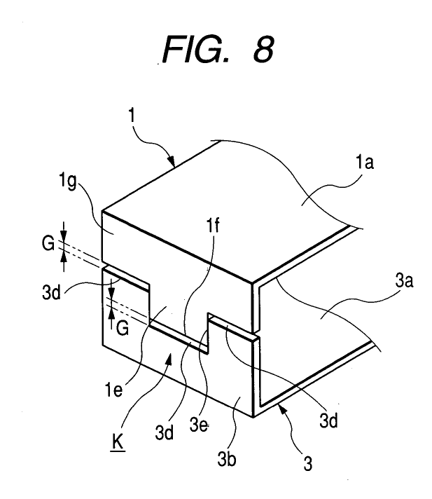

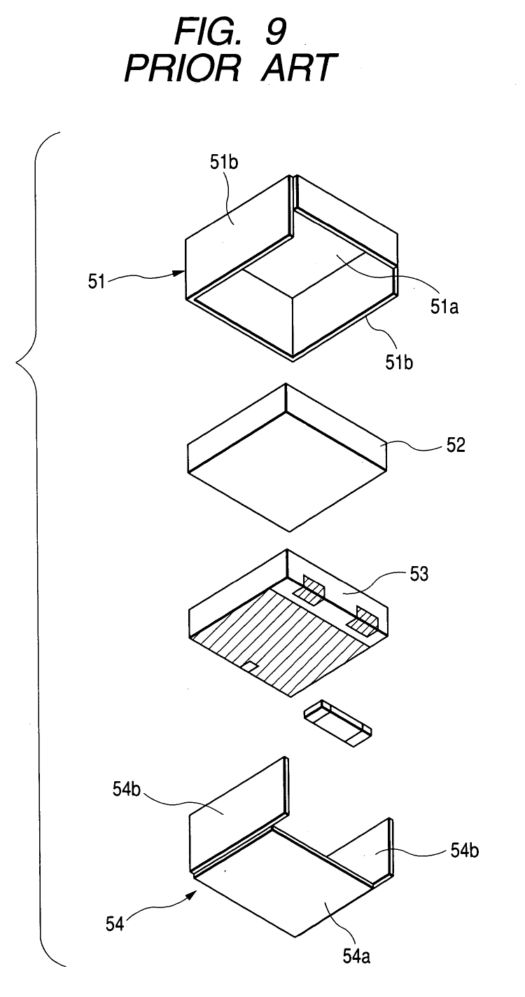

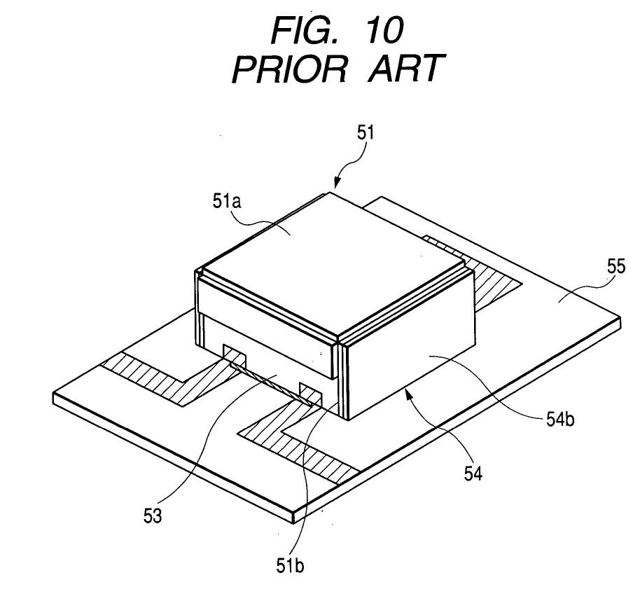

FIG. 6 is a view illustrating a method for manufacturing the non-reciprocal circuit element according to the present invention; FIG. 7 is a perspective view of main parts of first and second yokes in a non-reciprocal circuit element according to a second embodiment of the present invention; and FIG. 8 is a perspective view of main parts of first and second yokes in a non-reciprocal circuit element according to a third embodiment of the present invention.

Hereinafter, a first embodiment of a non-reciprocal circuit element according to the present invention will be described with reference to FIGS. 1 to 5. A first yoke 1 is made of a magnetic plate such as an iron plate. The first yoke 1 includes a rectangular upper surface plate 1a, concave portions 1b which forms connecting means K, tongue pieces 1c, and projection pieces 1d. The concave portions 1b are formed at both ends of the upper surface plate 1a which face each other. The tongue pieces 1c are bent downwards from each position of the concave portions 1b. The projection pieces 1d extends from an end of the upper surface plate 1a and is bendable.

A disc-shaped magnet 2 is disposed below the first yoke 1. An upper surface of the magnet 2 is attached to a lower surface of the first yoke 1 by using adhesive material.

A second yoke 3 is formed by a U-shaped magnetic plate. The second yoke 3 includes a rectangular bottom plate 3a, a pair of side plates 3b, and convex portions 3c. The pair of side plates 3b are bent upward from sides of the lower surface 3 which face each other. The convex portions 3c protrude from the upper end portions of the pair of side plates 3b and form the connecting means K.

As shown in FIGS. 4 and 5, the concave portions 1b of the first yoke 1 fit firmly to the convex portions 3c of the second yoke 2 so that the first yoke 1 and the second yoke 3 are connected with each other. Simultaneously, it causes the projection piece 1d of the first yoke 1 be protruded outside the side plate 3b.

The connecting means K is formed by convex and concave fitting of the convex portions 1b and the concave portions 3c. Thus, it allows the first and second yokes 1 and 3 to be connected with each other. Simultaneously, the convex portions 3c abut with the tongue pieces 1c.

The first and second yokes 1 and 3 are connected with each other to form a closed magnetic circuit therebetween. Further, when the first and second yokes 1 and 3 are connected with each other, a lower face (surface) of the first yoke 1 (including projection piece 1d) faces an edge 3d of the second yoke 2 disposed at an upper end of the side plate 3b. Also, between the lower face of the first yoke 1 and the edge 3d of the side plate 3b, a gap G is formed.

By moving at least one of the first and second yokes 1 and 3 upward and downward, a gap width G is adjusted (varied). When the first and second yokes 1 and 3 are moved upward and downward, the convex parts 3c are guided to the tongue pieces 1c.

The connecting means K (which is not shown in drawings) is soldered, so that the first and second yokes 1 and 3 are connected with each other. After the soldering process, if necessary, the projection piece 1d is bent, and a gap width G formed between a surface of the projection piece 1d and the edge 3d is minutely adjusted.

In the above embodiment, it has been described that the concave portions 1b is formed at the first yoke 1 and the convex portions 3c is formed at the second yoke 3, respectively. However, convex portions may be formed at the first yoke 1 and concave portions may be formed at the second yoke 3, respectively.

In addition, although the connecting means K is soldered in this embodiment, it is possible to solder the connecting means K and/or the gap. Furthermore, the connecting means K may use another construction in addition to the concave and convex fitting.

A flat ferrite member 4 is attached to the second yoke 3 in the state mounted on a bottom plate 3a of the second yoke 3. The ferrite member 4 is made of e.g. YIG (yttrium iron garnet).

The chip capacitor C1 includes an insulator 21 made of a plate shaped ceramic, a first electrode 22, and a second electrode 23. The first and second electrodes 22 and 23 are provided at both outer surfaces of the insulator 31 which face each other. Each of the first and second electrodes 22 and 23 is made of a silver. The chip capacitor C1 is disposed between the first and second electrodes 22 and 23 which face each other to have a predetermined capacitance.

In three chip capacitors C1, the first electrode 22 is soldered to a bottom plate of the second yoke 3, is attached to the second yoke 3, and is grounded to the second yoke 3.

First, second, and third central conductors 5, 6, and 7 include three pairs of bending portions 5a, 6a, and 7a which are provided at both ends of each of the central conductors 5, 6 and 7, connecting portions 5b, 6b, and 7b which are provided at one end of each of the bending portions 5a, 6a, and 7a, and terminal portions 5c, 6c, and 7c which bend at the other end of each of the bending portions 5a, 6a, and 7a, respectively. Each of the first, second, and third central conductors 5, 6, and 7 is formed by a thin conductive plate such as a copper.

The first, second, and third central conductors 5, 6, and 7 are placed on different surfaces in the longitudinal direction by interposing dielectrics 8 made of an insulator therebetween. The first, second, and third central conductors 5, 6, and 7 partially intersect one another in the longitudinal direction. The first, second, and third central conductors 5, 6, and 9 are separated from one another by an angle of 120 degrees.

The first, second, and third central conductors 5, 6, and 7 are mounted on the ferrite member 4 through the dielectrics 8.

The terminal portions 5c, 6c, and 7c of the first, second, and third central conductors 5, 6, and 7 are guided outside the second yoke 3, respectively. Simultaneously, respective center portions of the terminal portions 5c, 6c, and 7c are soldered onto the second electrode 23 of the chip capacitor C1 to be electrically connected to each other.

In addition, the connecting portions 5b, 6b, and 7b are soldered to a bottom plate 3a of the second yoke 3 to be electrically connected to each other under the grounded state.

Above the first, second, and third central conductors 5, 6, and 7, the magnet 3 provided on the first yoke 1 is arranged. In this state, by connecting an upper surface plate 1a of the first yoke 1 and side plates 3b of the second yoke 3 with each other, when the magnet 2 and the ferrite member 4 interpose between the first and second yokes 1 and 3, a non-reciprocal circuit element having a circulator or an isolator is obtained.

Moreover, the non-reciprocal circuit element having the above-mentioned construction, is mounted on a circuit board having a conductor pattern although it is not shown in drawings. The terminal portions 5c, 6c, and 7c of the first, second, and third central conductors 5, 6, and 7 are soldered in a wiring conductor pattern. A bottom plate 3a of the second yoke 3 is soldered in a grounding conductor pattern.

Generally, due to a manufacturing variation, variation in a magnetic force of the magnet 2 occurs. When a non-reciprocal circuit element is manufactured by using the above magnet 2, the magnetic flux density between the first and second yokes 1 and 3 changes due to variation in the magnetic force. Accordingly, the variation occurs in a magnetic bias to thereby increase the variation in a resonant frequency.

According to the present invention, since the gap G between the first and second yokes 1 and 3 is formed, in the non-reciprocal circuit element, a gap width G may be varied (adjusted). Accordingly, in the gap G, the magnetic flux density between the first and second yokes 1 and 3 can be adjusted (controlled). That is, the magnetic flux density is adjusted in response to a different magnetic force of the magnet 2, thereby causing reduction in the variation in magnetic bias and in the variation in the resonant frequency.

Hereinafter, a method for manufacturing a non-reciprocal circuit element according to the present invention will be explained with respect to FIG. 6 hereinafter. Between the first and second yokes 1 and 3, the ferrite member 4 on which the magnet 2 and the first, second, and third central conductors 5, 6, and 7 are mounted is arranged. As shown in FIG. 6, accordingly, the first and second yokes 1 and 3 are connected with each other by the connecting means K.

Jigs 9 such as the elastic member made of a urethane rubber or a metal plate having elasticity or a flat shaped spacer are inserted into the gap G. Before connecting the first and second yokes 1 and 3, the jigs 9 are preferably inserted into positions to be the gap G in advance.

Thereafter, at least one of the first and second yokes 1 and 3 is pressurized so as to reduce the gap width G. At this time, the pressuring operation is performed against the connection force (interposing force) of the connecting means K. Accordingly, the gap width G is adjusted that allows the magnetic flux density between the first and second yokes 1 and 3 to be adjusted (controlled).

Subsequently, after soldering the connecting means K, the jigs 9 are removed from the gap G to complete manufacturing of the non-reciprocal circuit element according to the present invention.

After performing the soldering process, if necessary, the projection piece 1d is bent, and a gap width G formed between a surface of the projection piece 1d and the edge 3d is minutely adjusted.

In another method for manufacturing a non-reciprocal circuit element according to the present invention, a plurality of jigs 9 are prepared and the magnetic force of the magnet 2 is previously measured every lot. The jigs 9 are formed by spacers having different thicknesses.

Subsequently, through the magnitude of the magnetic force in the magnet 2, data with respect to the thickness of the used jigs 9 is obtained. The jig 9 is selected corresponding to the magnitude of the magnetic force measured every manufacturing lot of the magnet 3. The selected jig 9 is inserted into the gap G.

Then, at least one of the first and second yokes 1 and 3 is pressurized so as to reduce the gap width G. The pressuring operation is performed against the connecting force (interposing force) of the connecting means K. The pressuring operation is performed until the gap width G becomes the thickness of the jig 9.

As a result, the magnetic flux density between the first and second yokes 1 and 3 is adjusted (controlled). After soldering the connecting means K, the jigs 9 are removed from the gap G to complete manufacturing of the non-reciprocal circuit element according to the present invention.

Hereinafter, a second embodiment of a non-reciprocal circuit element according to the present invention will be described with reference to FIG. 7.

A pair of convex portions 1e bent downward from an upper surface plate 1a are formed at the first yoke 1. A concave portion 3e is formed at a side plate 3b of the second yoke 3. The concave portion 3e is firmly fitted to the convex portions 1e.

Through convex and concave fitting of the convex portions 1e and the concave portion 3e, the connecting means K is formed. Between an edge 3d of the side plate 3b and a lower face (surface) of an upper surface plate 1a, a gap G is formed. Between the edge 3d of the side plate 3b and an edge 1f of the convex portion 1e, a gap G is also formed.

Except for that, the non-reciprocal circuit element according to the second embodiment of the present invention has the same construction as that of the non-reciprocal circuit element according to the first embodiment of the present invention. A method for manufacturing the non-reciprocal circuit element according to the second embodiment of the present invention is equal to the method for manufacturing the non-reciprocal circuit element according to the first embodiment of the present invention.

A third embodiment of the non-reciprocal circuit element according to the present invention will now be described with reference to FIG. 8. A pair of side surface plates 1g bent downwards from an upper surface plate 1a and the concave portion 1e protruded downwards from an end portion of the side surface plate 1g are formed at the first yoke 1. The concave portion 3e firmly fitted to the convex portion 1e is provided at a side plate 3b of the second yoke 3.

By convex and concave fitting of the convex portions 1e and the concave portion 3e, the connecting means K is formed. A gap G is formed between an edge 3d of the side plate 3b and a side surface plate 1g. A gap G is also formed between the edge 3d of the side plate 3b and an edge 1f of the convex portion 1e.

Another construction of the non-reciprocal circuit element according to the third embodiment of the present invention is the same as the non-reciprocal circuit element according to the first embodiment of the present invention. A method for manufacturing the non-reciprocal circuit element according to the third embodiment of the present invention is the same as the method for manufacturing the non-reciprocal circuit element according to the first embodiment of the present invention.

In the third embodiment of the present invention, a concave portion may be provided at the side surface plate 3g and a convex portion may be provided at the side plate 3b, respectively.

Furthermore, in the non-reciprocal circuit element of the present invention, surfaces of the first and second yokes 1 and 3 may face each other. A gap G may be formed between the surfaces of the first and second yokes 1 and 3.

As is clear from the foregoing description, the non-reciprocal circuit element includes a flat ferrite member; first, second, and third central conductors disposed on the ferrite member, the central conductors being installed at respective different surfaces thereof by interposing dielectrics therebetween, and the central conductors being partially intersected upward and downward; a magnet arranged on the first, second, and third central conductors; a first yoke disposed so as to cover the magnet; and a second yoke arranged at a lower surface side of the ferrite member for defining a closed magnetic circuit together with the first yoke, and a gap which is capable of controlling the magnetic flux density is provided between the first and second yokes. In accordance with the present invention, although the variation occurs in a magnitude of the magnetic force, the gap width may be changed (adjusted). Accordingly, in the gap, it is possible to adjust (control) the magnetic flux density between the first and second yokes 1 and 3. That is, it is possible to adjust the magnetic flux density in response to different magnetic forces of a magnet, thereby causing reduction in the variation in magnetic bias and reduction in the variation in the resonant frequency.

Since an opening is formed as a gap, the magnetic flux density between the first and second yokes significantly increases, and it is possible to adjust easily.

Since the first and second yokes are connected with each other by the connecting means, the first and second yokes are held by the connecting means to temporarily stop. Therefore, it is possible to easily adjust the gap by the temporarily stop state.

The first and second yokes are connected with each other by the connecting means and/or by soldering the gap, so thus it is possible to securely bond the first and second yokes to each other.

A concave portion is provided at one of the first and second yokes, a convex portion is provided at the other of the first and second yokes, and the connecting means is formed by concave and convex fitting of the concave and convex portions. Accordingly, the construction of the connecting means can be simplified, it is possible to provide the excellent productivity and assembling property.

Since the gap is formed between respective edges of the first and second yokes to be mutually faced, a construction of the gap can be simplified. Without making the first and second yokes greater in forming the gap, it is possible to easily reduce the size of the gap.

The first yoke includes an upper surface plate and at least one pair of side surface plates bent downward from the upper surface plate; the second yoke includes a bottom plate and at least one pair of side plates bent upward from the lower plate; the connecting means is formed between the at least one pair of side surface plates of the first yoke and the at least one pair of side plates of the second yoke and the gap is formed between the side surface plate and edges of the side plate which face each other. So thus it is possible to obtain a simple construction. Further, without making the first and second yokes greater during forming the gap, it is possible to easily reduce the size of the gap.

Furthermore, since the gap is formed between surfaces of the first and second yokes which face each other, a facing area between the first and second yokes in the gap increases. Accordingly, the magnetic flux density between the first and second yokes in the gap is greatly changed and is easily adjusted.

The gap is formed between a surface of one of the first and second yokes and an edge of the other of the first and second yokes which face the surface of the one of the first and second yokes. So thus it is possible to obtain a simple construction. Further, without making the first and second yokes greater during forming the gap, it is possible to easily reduce the size of the gap.

The an upper surface plate; the second yoke includes a bottom plate and at least one pair of side plates bent upwards from the upper surface of the first yoke; and the connecting means is formed between the upper surface of the first yoke and the at least one pair of side plates of the second yoke; and the gap is formed between the edge of the side plate and a surface of the upper surface plate. So thus it is possible to obtain a simple construction. Further, without making the first and second yokes greater during forming the gap, it is possible to easily reduce the size of the gap.

The upper surface plate of the first yoke includes a concave portion provided at an edge of the upper surface plate, and a tongue piece bent at a position of the concave portion downward. The at least one pair of side plates include the convex portion which is engaged with the concave portion, and the convex portion contacts with the tongue piece. Accordingly, when the yoke is moved, the convex portion guides a tongue piece to be moved. It is possible to easily adjust an assembling and a gap.

the upper surface plate of the first yoke includes a projection piece which is extended and bent from an edge of the upper surface plate, and a gap width is adjusted between the projection piece and the edge of the side plate by bending the projection piece. Thus, a gap can be minutely adjusted after a soldering process.

The present invention provides a method for manufacturing a non-reciprocal circuit element comprising a flat ferrite member; first, second, and third central conductors disposed on the ferrite member, the central conductors being provided on different surfaces in the longitudinal direction by interposing dielectrics therebetween, and the central conductors being partially. intersected in the longitudinal direction; a magnet arranged on the first, second, and third central conductors; a first yoke disposed so as to cover the magnet; a second yoke arranged at a lower surface side of the ferrite member for defining a closed magnetic circuit with the first yoke; and a gap provided between the first and second yokes for controlling a magnetic flux density, the method comprising the steps of adjusting a gap width by moving at least one of the first and second yokes; and adjusting a magnetic flux density between the first and second yokes in the gap. Accordingly, the present invention provides a method for manufacturing a non-reciprocal circuit element, which easily adjusts a magnetic flux density between the first and second yokes in a gap, namely, the magnetic flux density against different magnetic forces of a magnet.

The first and second yokes are connected with each other by connecting means, and a gap width is adjusted by moving at least one of the first and second yokes against a connection force of the connecting means. Thus, the first and second yokes are held by connecting means that allows the first and second yokes to temporarily stop. In the temporary stop state, a gap is also adjusted. Consequently, the present invention provides a method for manufacturing a non-reciprocal circuit element that easily performs an adjusting operation.

Because a gap width is adjusted by inserting a jig into the gap, the present invention provides a method for manufacturing a non-reciprocal circuit element that easily perform an adjusting operation.

Because the jig is formed by an elastic member having elasticity, and a gap width is adjusted by moving at least one of the first and second yokes against elasticity of the elastic member, the present invention provides a method for manufacturing a non-reciprocal circuit element that easily perform an adjusting operation.

Because a plurality of jigs having different thicknesses are used, a magnetic force of the magnet is previously measured every lot, the plurality of jigs are selected every lot of the magnet so as to adjust a gap width, the present invention provides a method for manufacturing a non-reciprocal circuit element that easily perform an adjusting operation.

After adjusting a gap width, the first and second yokes are connected with each other by the connecting means and/or by soldering the gap. Therefore, the present invention provides a method for manufacturing a non-reciprocal circuit element that easily performs an adjusting operation.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A non-reciprocal circuit element comprising:
a flat ferrite member;
first, second, and third central conductors disposed on the ferrite member, the central conductors being provided on different surfaces in a longitudinal direction by interposing dielectrics therebetween, and the central conductors being partially intersected in the longitudinal direction;
a magnet arranged on the first, second, and third central conductors;
a first yoke disposed so as to cover the magnet; and
a second yoke arranged at a lower surface side of the ferrite member for defining a closed magnetic circuit together with the first yoke,
wherein a gap which is capable of controlling the magnetic flux density is provided between the first and second yokes.

2. The non-reciprocal circuit element according to claim 1, wherein an opening is formed as the gap.

3. The non-reciprocal circuit element according to claim 1, wherein the first and second yokes are connected with each other by connecting means.

4. The non-reciprocal circuit element according to claim 3, wherein the first and second yokes are connected with each other by at least one of the connecting means and by soldering the gap.

5. The non-reciprocal circuit element according to claim 3, wherein a concave portion is provided at one of the first and second yokes, a convex portion is provided at the other of the first and second yokes, and the connecting means is formed by concave and convex fitting of the concave and convex portions.

6. The non-reciprocal circuit element according to claim 5, wherein the gap is formed between edges of the first and second yokes which face each other.

7. The non-reciprocal circuit element according to claim 6, wherein the first yoke includes an upper surface plate and at least one pair of side surface plates bent downward from the upper surface plate; the second yoke includes a bottom plate and at least one pair of side plates bent upward from the lower plate; the connecting means is formed between the at least one pair of side surface plates of the first yoke and the at least one pair of side plates of the second yoke and the gap is formed between the side surface plate and edges of the side plate which face each other.

8. The non-reciprocal circuit element according to claim 5, wherein the gap is formed between surfaces of the first and second yokes which face each other.

9. The non-reciprocal circuit element according to claim 5, wherein the gap is formed between a surface of one of the first and second yokes and an edge of the other of the first and second yokes which face the surface of the one of the first and second yokes.

10. The non-reciprocal circuit element according to claim 9, wherein the first yoke includes an upper surface plate; the second yoke includes a bottom plate and at least one pair of side plates bent upwards from an upper surface of the first yoke; and the connecting means is formed between an upper surface of the first yoke and the at least one pair of side plates of the second yoke; and the gap is formed between the edge of the side plate and a surface of the upper surface plate.

11. The non-reciprocal circuit element according to claim 10, wherein the upper surface plate of the first yoke includes a concave portion provided at an edge of the upper surface plate, and a tongue piece bent at a position of the concave portion downward; and the at least one pair of side plates include the convex portion which is engaged with the concave portion, and the convex portion contacts with the tongue piece.

12. The non-reciprocal circuit element according to claim 10, wherein the upper surface plate of the first yoke includes a projection piece which is extended and bent from an edge of the upper surface plate, and a gap width is adjusted between the projection piece and the edge of the side plate by bending the projection piece.

13. A method for manufacturing a non-reciprocal circuit element comprising a flat ferrite member; first, second, and third central conductors disposed on the ferrite member, the central conductors being provided on different surfaces in a longitudinal direction by interposing dielectrics therebetween, and the central conductors being partially intersected in the longitudinal direction; a magnet arranged on the first, second, and third central conductors; a first yoke disposed so as to cover the magnet; a second yoke arranged at a lower surface side of the ferrite member for defining a closed magnetic circuit with the first yoke; and a gap provided between the first and second yokes for controlling a magnetic flux density, the method comprising:
adjusting a gap width by moving at least one of the first and second yokes; and
adjusting a magnetic flux density between the first and second yokes in the gap.

14. The method according to claim 13, wherein the first and second yokes are connected with each other by connecting means, and a gap width is adjusted by moving at least one of the first and second yokes against a connection force of the connecting means.

15. The method according to claim 14, wherein a gap width is adjusted by inserting a jig into the gap.

16. The method according to claim 15, wherein the jig is formed by an elastic member having elasticity, and a gap width is adjusted by moving at least one of the first and second yokes against elasticity of the elastic member.

17. The method according to claim 15, wherein a plurality of jigs having different thicknesses are used, a magnetic force of the magnet is previously measured every lot, the plurality of jigs are selected every lot of the magnet so as to adjust a gap width.

18. The method according to claim 14, wherein after adjusting a gap width, the first and second yokes are connected with each other at least one of by the connecting means and by soldering the gap.
